(19) United States
(12) Patent Application Publication
(10) Pub. No.: US 2008/0000092 A1
(43) Pub. Date: Jan. 3, 2008

(54) Spifork

(76) Inventor: Max Vanguard, Cincinnati, OH (US)

Correspondence Address: MAX VANGUARD / DBA / DMECH, INC., STE. #3, 4233 SOUTH AVE., CINCINNATI, OH, 45236, US

(21) Appl. No.: 11/478,142

(22) Filed: Jun. 30, 2006

(51) Int. Cl. A47J 43/28

(52) U.S. Cl. 30/147

(57) ABSTRACT

The “SPIFORK” (spīf'•ork), a single piece construction, combination “all-in-one” type utensil used for eating is disclosed. The utensil features a combined fork and spoon bowl facility comprising the first implement means and a knife facility comprising the second implement means. The utensil additionally features a notch, perforation or indentation in its handle portion to allow, via bending manually, for ease of separation of the combined fork and spoon facility from the knife facility, at the user's option. The utensil may be made, e.g., of biodegradable or recyclable materials.

### PARENT CASE TEXT

This application is a continuation of Application No. 60/694,550 filed Jun. 29, 2005.

### SUMMARY OF THE INVENTION

The invention is an “all-in-one” combination utensil consisting of single piece construction and used in consuming foods and liquids, which is characterized by a handle means and two (2) distinct implement means. The handle means has a length defined by two ends, both of which join the implement means. The middle portion of the handle means is the portion of the device which meets the central portion of the user's hand. As such, in the apparatus described and claimed herein, this handle portion is nonlinear and may be, e.g., curved, rounded, cylindrical, spherical or some other geometrical form which facilitates reception in the hand of the user. At the first implement means, there is the combined fork and spoon bowl facility. At the second implement means, there is the knife facility. In the middle length area of the handle means, there is a notch, perforation or indentation, the purpose of which is to permit the user to easily separate or “snap apart” the device, via bending manually, so as to utilize the implement means separately, if so desired. The proximal and distal ends of the described implement means, of course, define the length of the apparatus and flank/bound the handle means, which also has a front side and a backside. Along the backside of the handle, there are positioned at least one, and preferably, more than one, curved recesses. These curved recesses provide several advantages including, but not limited to, facilitating grip strength, user ease and comfort, and so forth. Other advantages arising inherently there from will be recognized by the skilled artisan.

The two implement means join the handle means at two distinct, separate ends. The first implement means comprises a concave recess which facilitates reception of a comestible number of tines to produce a fork means. Additionally, the second implement means includes a cutting edge on one lateral side of the implement means, which can be serrated.

Reference is now made to a brief description of the figures which follow, and the detailed description of preferred embodiments, which explain the invention in detail.

### BRIEF DESCRIPTION OF THE FIGURES

FIG. 1 is a trimetric front side view of the preferred embodiments of the apparatus described herein.

FIG. 2 is a trimetric backside view of the preferred embodiments of the apparatus described herein.

### DETAILED DESCRIPTION OF THE PREFERRED EMBODIMENTS

With reference to the accompanying figure, the invention is a combination utensil for eating 1, having a handle portion 7 and implement portions 8 and 9. With reference to the handle portion 7, its length is defined by a first proximal end 4, which leads into, or is connected with implement portion 8 and a second proximal end 6, which leads into, or is connected with implement portion 9. The handle portion 7, as will be seen from the drawings, is adapted for reception by the user's hand.

Positioned roughly at or around the midpoint of the handle portion 7, is a notch, indentation and/or perforation 5, which provides a means which would enable the user to cleanly “snap apart” the utensil, by manually bending the two ends which flank the notch, indentation and/or perforation back and forth, so as to utilize the implement portions separately, if so desired.

The first implement portion 8 is defined by a first proximal end 4 and a first distal end 2, which define its length. The first proximal end 4 defines the start of the first implement end. The first proximal end is characterized by the beginning of the concave recess 8, which is intended to act as a spoon means. The first distal end 2, is characterized by a plurality of tines 10, which act as a fork means.

The second implement portion 9 is defined by a second proximal end 6 and a second distal end 3, which define its length. The second proximal end 6 defines the start of the second implement end. The second proximal end is characterized by the handle leading into the knife blade for the second implement portion 9. The second distal end 3, is characterized by a blade and/or cutting means, which may be serrated or unserrated and is intended to act as a knife means.

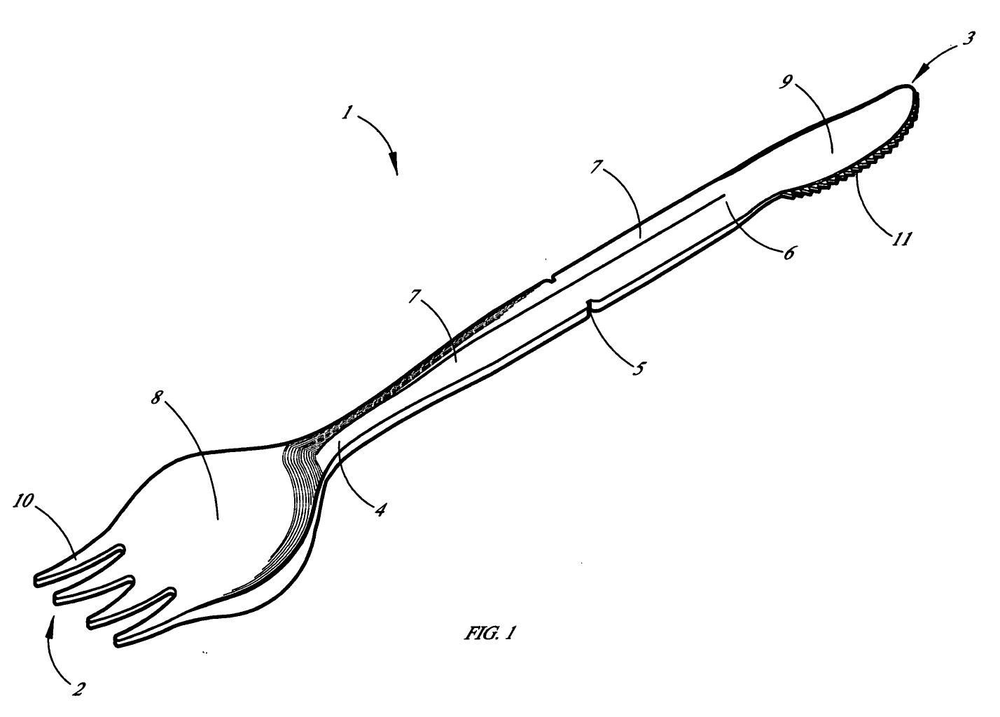

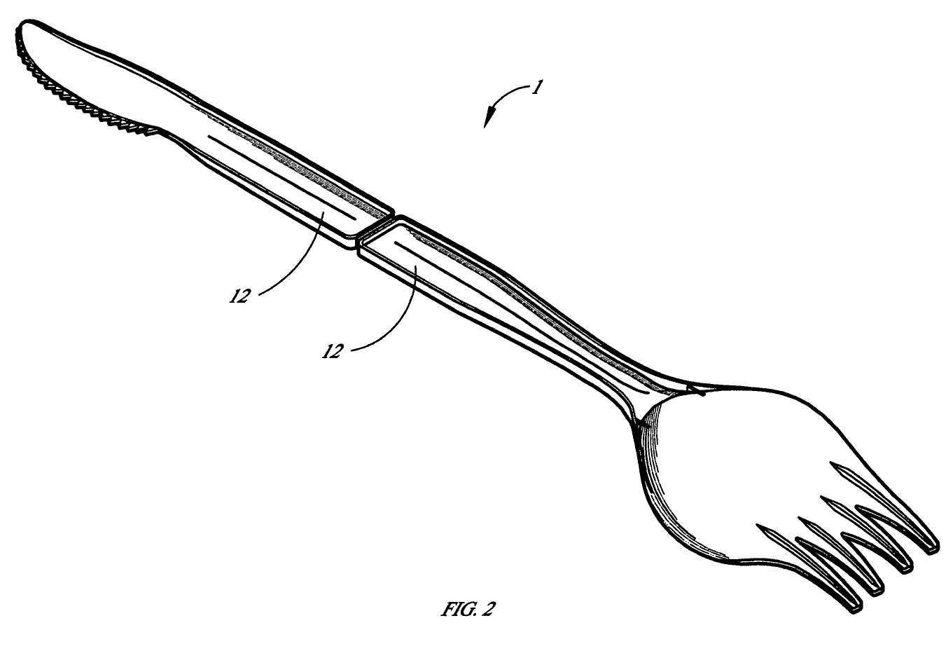

FIG. 1. shows the front side trimetric view of the invention 1, while in FIG. 2, the backside of the device 1 can be seen, and as such, a plurality of recesses 12 may be seen positioned thereon. It is a feature of the invention that at least one, and preferably more of these recesses are present on the back, or dorsal side of the handle portion of the device. Additionally, a plurality of raised strengthening ridges and/or ribs are illustrated in FIG. 2, on the backside in support of the fork tines.

The dimensions of the device may of course vary, but some examples of practical dimensions are an overall length of between 9 and 10 inches, an approximate handle length of 5¼ inches, and implement end lengths of 2¼ inches for the combined fork and spoon facility and 2¼ inches for the knife facility. The widest portion of the handle, in such a case, can be approximately ½ inch wide, with a first terminal end leading into the combined fork and spoon means having dimensions of ¼ inch wide and a second terminal end leading into the knife means having dimensions of ⅜ inch wide. The spoon bowl of such a device can be approximately 1½ inches across at its widest portion and the tines approximately ½ inch long and ¼ inch apart from each other. The notch, perforation and/or indentation in the handle means can be located approximately at the midway point along the handle length and would extend across the width of the handle means. The cutting edge employed on the lateral side is preferably about 1½ to 2¼ inches long and may be a straight edge, curved and/or serrated. The recesses along the back of the handle portion, as shown in FIG. 2, may be placed anywhere along the length desired. Typically, if the handle length is 5¼ inches and a plurality of recesses are used, the associated strengthening ridges will extend along the length of the handle and be approximately ⅜ inch apart from each other at the widest portion and 3/16 inch apart from each other at the narrowest portion of the handle.

The choice of materials used to fabricate the apparatus may vary as well. For example, as the apparatus is primarily designed for disposal or recycling, the materials used may be any of the many plastics and moldable substances known to the manufacturing art for producing disposable tableware, as well as cellulose derivates such as wood, recycled wood pulp and chips, cardboard paper, and so forth. The skilled artisan will be aware of other available materials such as environmentally safe and nontoxic materials, all of which are encompassed by this invention.

It will be understood that the specification and examples noted in this section are merely for illustrative purposes only and are not limitative of the present invention and that other embodiments within the spirit and scope of the invention will suggest themselves to those skilled in the art.

### DESCRIPTION

1. Field of the Invention

This invention relates to a combination “all-in-one” eating utensil, consisting of single piece construction and comprising combined fork and spoon facilities in conjunction with a knife facility, which are readily separable and/or adaptable for ease of use at the user's option. More particularly, and henceforth known as the “SPIFORK”, it relates to “one-piece” eating utensils, with combined fork, spoon and knife facilities, which, if desired, can be recycled or disposed of.

The etymological derivation of the portmanteau word, “SPIFORK” (spīf'•ork), destined to become an entirely new lexical term in and of itself, is a combination of the digraphs ‘sp’ as derived from “spoon”, ‘-if’ as derived from “knife” and the trigraph ‘-ork’ as derived from “fork” (‘sp’+‘if’+‘ork’=“SPIFORK”).

2. Background and Prior Art

Combination utensils used for eating are well known in the art. The term “spork”, with specific reference to the ornamental design detailed in D388,664 (Gagnon, et al., 1998) for instance, which depicts the combination of spoon and fork elements, but not a knife element, being used in one utensil, is generally quite well known to the public at large.

Additional devices are also known which incorporate elements of knife and fork, but not spoon (U.S. Pat. No. 4,771,541); or combination of knife, spoon and fork (D190,198 & D147,119). These “combination utensils” as they will be described herein, are generally widely fabricated from disposable material(s), such as plastic, and are widely utilized or dispensed by restaurant type establishments, cafeterias, hospitals, airliners, schools, correctional institutions, etc., and are additionally often found at picnics, luncheons, and other similar occasions, where a great number of meals are served.

In a great many of these establishments, the food served is predominantly, or exclusively of the “sake out” variety, and hence, the recovery and/or reuse of the utensils used to consume the food served would generally not be deemed feasible and/or possible.

There is little doubt that the volume of such utensils in use has contributed to the number of patents in the field. Thusly, in U.S. Pat. No. D147,119, which is of course, a very early example of the art, one finds the basic combination of a handle, a spoon bowl and a combination of knife edge and fork tines in the apparatus. This has been the basic design topology of most similar devices prior to the conception of the “SPIFORK”.

As is well recognized, one does not use a spoon, fork and knife in the same manner. When food is consumed with a fork or a spoon, no pressure, or very little pressure, need be applied to effectively utilize the apparatus. However, when a knife and/or fork is used, it will be appreciated that pressure must be applied to the knife for cutting, or to the fork for holding the foodstuff to be cut. This difference in the manner in which the utensils are used means that different considerations and/or criteria are employed as features in the design and construction of different combination utensils. For example, in a device of the type depicted in U.S. Pat. No. D190,198, where the combination is of a spoon bowl and fork tines, the device is clearly intended to be used for liquids, soft foods, and material which is already in small pieces. Such a device may be constructed of inexpensive materials as very little pressure need be applied thereto.

However, the design topology of the “SPIFORK” is unique in the art, which heretofore, to the best of the inventor's knowledge, has neither taught nor suggested a combination “all-in-one” single piece utensil which features a construction comprised of a combined fork and spoon bowl means in conjunction with a distinctly separate knife means which is readily detachable at the user's option. The “SPIFORK” is adaptable for ease of use, comfort of the user, versatility in aiding the user's consumption of solid foods with its protruding tines equally as well as liquid foodstuffs with its pronounced spoon bowl, and most importantly, permits the utilization of a number of readily available inexpensive materials in its construction.

Additional important aims of the “SPIFORK” are clearly directed at the conservation of materials involved in its construction, and reflexively, conservation of wasted materials upon its disposal, which is sounder for the health of the environment, as it would clearly require less material by both volume and weight to manufacture one (1) “SPIFORK” versus the three (3) separate traditional utensils of fork, spoon and knife, for which the “SPIFORK” is intended to provide a clearly superior substitute. By this same contrast, the “SPIFORK” also provides the distinct advantage of serving as a superlative cost cutting measure as it represents an outstanding alternative to purchasing three (3) separate traditional eating utensils per meal.

It is to a device of this type towards which the invention is directed.

The embodiments of the invention in which an exclusive property or privilege is claimed are defined as follows:

1. An “all-in-one” combination eating utensil, consisting of single piece construction and comprising:
(i) a handle portion having a front side and a backside and having a length defined by a first non-linear end which leads into a first implement portion comprising a combined fork and spoon facility and a second end leading into a second implement portion comprising a knife facility;
(a) the backside of said handle portion having at least one (1) curved recess along its length,
(b) the backside of said device having a plurality of raised strengthening ridges and/or ribs in support of the fork tines,
(c) the lateral blunt edge of the knife means having a raised strengthening ridge and/or rib in support of the opposing lateral cutting edge of the knife means,
(d) said handle portion having a notch, indentation and/or perforation adapted for ease of use in separating the combined fork and spoon facility from the knife facility; said notch, indentation and/or perforation structure located roughly at the midway point along the length of said handle in between the implement portions and not continuing into or onto said implement portions.
(ii) implement portions comprising:
(e) a first proximal end connected to said first distal end of said handle portion; and a second proximal end connected to said second distal end of said handle portion,
(f) two (2) opposing lateral sides which define a concave recess which tapers from a narrowest portion at said first proximal end to a wider portion at first distal end, said first distal end terminating in an alternating series of a plurality of “U” and/or “V” shaped indentations and “V” shaped extensions which define a plurality of pronounced and/or protruding tines, extending directly from said first distal end, wherein the number of said indentations is one (1) more than the number of extensions,
(g) two (2) end tines, each of which is defined by one (1) of said opposing lateral sides and one (1) of said “U” and/or “V” shaped indentations,
(h) the entire plurality of pronounced and/or protruding tines, as described above, comprise the fork means of the device;
(i) a concave recess, as described above, comprise a spoon bowl means which is appreciably dished and/or bowl shaped in nature;
(j) a cutting means, which extends from said second proximal end along a portion of the opposing lateral side, terminating at the said second distal end of the utensil, and,
(k) a notch, perforation and/or indentation located roughly at or around the midpoint of the said handle portion which would permit the user to cleanly “snap apart” the device into two (2) separate portions, if so desired, via bending back and forth manually.

2. Combination utensil of claim 1, wherein said handle means comprises a plurality of curved recesses along its backside length.

3. Combination utensil of claim 1, wherein said cutting edge is serrated.

4. Combination utensil of claim 1, wherein said utensil is comprised of recyclable or reusable material.

5. Combination utensil of claim 4, wherein said recyclable material is a cellulose derived material.

6. Combination utensil of claim 4, wherein said recyclable material comprises wood.

7. Combination utensil of claim 5, wherein said recyclable material comprises a biodegradable plastic.

8. Combination utensil of claim 1, wherein said utensil is comprised of non-toxic material.

9. Combination utensil of claim 1, wherein said utensil is comprised of environmentally safe material.
